(19) United States
(12) Patent Application Publication
(10) Pub. No.: US 2005/0094681 A1
(43) Pub. Date: May 5, 2005

(54) Tunable laser source

(76) Inventors: Shosuke Miyaki, Tokyo (JP); Keisuke Asami, Tokyo (JP)

Correspondence Address: FISH & RICHARDSON P.C., CITIGROUP CENTER 52ND FLOOR, 153 EAST 53RD STREET, NEW YORK, NY, 10022-4611, US

(21) Appl. No.: 10/980,566

(22) Filed: Nov. 3, 2004

(30) Foreign Application Priority Data
Nov. 4, 2003 (JP) P. 2003-374158

(51) Int. Cl. H01S 3/10

(52) U.S. Cl. 372/20; 372/102

(57) ABSTRACT

A tunable laser source that stably outputs high-output light with reduced spontaneous emission light is to be realized. This invention is an improvement of a tunable laser source of external resonator type. This apparatus comprises a wavelength selecting unit for selecting a wavelength of incident light and emitting the light of the selected wavelength, an optical amplifier unit for making light incident on the wavelength selecting unit from one end, and a mirror for reflecting light from the other end of the optical amplifier unit directly to the wavelength selecting unit. The wavelength selecting unit feeds the light from the one end of the optical amplifier unit back to the optical amplifier unit and emits the light from the mirror as output light.

### BACKGROUND OF THE INVENTION

1. Field of the Invention

This invention relates to a tunable laser source of external resonance type using a semiconductor laser, and particularly to a tunable laser source that stably outputs high-output light with less spontaneous emission light.

2. Description of the Related Art

FIG. 1 shows the structure of a tunable laser source of Littman layout that has been conventionally used (for example, see JP-A-2000-164980 (paragraph 0002, FIG. 4), and Karen Liu and Michael G. Littman, “Novel geometry for single-mode scanning of tunable lasers,” OPTICS LETTERS, Vol. 6, No. 3 (March 1981), pp. 117-118). In FIG. 1, an optical amplifier unit 10 has a semiconductor laser 11, a first lens 12, and a second lens 13. The semiconductor laser 11 has an antireflection film 11a at its one end. The first lens 12 collimates light emitted from the one end (where the antireflection film 11a is provided) of the semiconductor laser 11 and emits the collimated light. The second lens 13 collimates light emitted from the other end of the semiconductor laser 11 and emits the collimated light.

A wavelength selecting unit 20 has a diffraction grating 21, a wavelength selecting mirror 22, and a mirror rotating unit 23. The wavelength selecting unit 20 selects a wavelength of light made incident from one end of the optical amplifier unit 10 and feeds the light of the selected wavelength back to the optical amplifier unit 10. The diffraction grating 21 performs wavelength distribution of the light from the optical amplifier unit 10 and the light from the wavelength selecting mirror 22. The wavelength selecting mirror 22 reflects the light that is wavelength-distributed by the diffraction grating 21, to the diffraction grating 21. The mirror rotating unit 23 rotates the wavelength selecting mirror 22, thus selecting a wavelength of the light to be fed back to the optical amplifier unit 10 by the diffraction grating 21. The rotation axis about which the rotating unit 23 rotates the wavelength selecting mirror 22 is parallel to the direction along the grooves of the diffraction grating 21. The intersection of a line extending from the diffraction surface of the diffraction grating 21 and a line extending from the reflection surface of the wavelength selecting mirror 22 further intersects a line extending from a surface that forms an external resonator, and the center of rotation of the wavelength selecting mirror 22 is at this intersection.

An optical isolator 30 transmits light made incident from the other end of the optical amplifier unit 10 and emits the transmitted light as output light. The optical isolator 30 reduces the light that is emitted from the optical amplifier unit 10, then transmitted through the optical isolator 30 and returning to the optical amplifier unit 10 (so-called return light).

The operation of this apparatus will now be described.

The light emitted from the one end of the semiconductor laser 11 is collimated by the first lens 12 and becomes incident on the diffraction grating 21. Then, the light incident on the diffraction grating 21 is diffracted by the diffraction grating 21, then is distributed in wavelength at a different angle for each wavelength, and becomes incident on the wavelength selecting mirror 22. Of the light incident on the wavelength selecting mirror 22, only light having a desired wavelength is reflected on the same optical path to the diffraction grating 21. The wavelength of light to be reflected on the same optical path is selected by the mirror rotating unit 23.

The light incident on the diffraction grating 21 is again distributed in wavelength, and only the light having the wavelength selected by the wavelength selecting unit 20 is converged on the semiconductor laser 11 by the first lens 12 and fed back. The other end of the semiconductor laser 11 and the wavelength selecting mirror 22 form an external resonator, which performs laser oscillation.

On the other hand, the light emitted from the other end where the antireflection film la is not provided is collimated by the second lens 13, then transmitted through the optical isolator 30 and emitted as output light. Moreover, as the wavelength selecting mirror 22 is rotated by the mirror rotating unit 23, the wavelength of the light fed back to the optical amplifier unit 10 from the wavelength selecting unit 20 can be tuned, and wavelength sweep of the output light is performed when necessary.

The use of such Littman layout as shown in FIG. 1 enables restraining mode hop at the time of tuning. In the output light, the single wavelength selected by the wavelength selecting unit 20 is dominant. However, since the output light also includes spontaneous emission light of a broad wavelength range emitted directly to the second lens 13 from the semiconductor laser 11 itself, the output light has a poor S/N ratio. Therefore, the Littman layout is not suitable for the use in measuring wavelength loss characteristics of optical components for optical communications that require a large dynamic range, such as a notch filter.

Thus, to realize output light with reduced spontaneous emission light, a tunable laser source using diffracted light as output light or a tunable laser source using a tunable filter is used.

First, the tunable laser source that outputs diffracted light will be described (see, for example, JP-A-11-126943(paragraphs 0021 to 0031, FIGS. 1 and 2)).

FIG. 2 is a view showing the structure of the conventional tunable laser source that outputs diffracted light. In FIG. 2, the same elements as those shown in FIG. 1 are denoted by the same numerals and will not be described further in detail. In FIG. 2, a beam splitter 40 for splitting diffracted light from the diffraction grating 21 into two light beams is provided between the first lens 12 and the diffraction grating 21. The second lens 13 of the optical amplifier unit 10 and the optical isolator 30 are not provided.

The operation of such an apparatus is substantially similar to the operation of the apparatus shown in FIG. 1 but differs in that the beam splitter 40 splits the diffracted light from the diffraction grating 21. One of the light beams is fed back to the semiconductor laser 11 via the first lens 12, as in the apparatus shown in FIG. 1. Of the other light beam reflected at 90° by the beam splitter 40, only light of a desired wavelength transmitted through an optical isolator, not shown, and a slit, not shown, is emitted as output light.

Next, the tunable laser source with a tunable filter will be described (see, for example, JP-A-2003-69146 (paragraphs 0014 to 0017, FIG. 4)).

FIG. 3 is a view showing the structure of the conventional tunable laser source with a tunable filter. In FIG. 3, the same elements as those shown in FIG. 1 are denoted by the same numerals and will not be described further in detail. In FIG. 3, a second wavelength selecting unit 50 for selecting a wavelength of light outputted from the optical isolator 30 is provided.

The second wavelength selecting unit 50 has a diffraction grating 51 and a diffraction grating rotating unit 52. The second wavelength selecting unit 50 selects a wavelength of light outputted from the optical isolator 30 and emits the light of the selected wavelength as output light. The diffraction grating 51 performs wavelength distribution of the light from the optical isolator 30. The diffraction grating rotating unit 52 rotates the diffraction grating 51 to adjust the direction in which the diffraction grating 51 emits light of a desired wavelength, thus selecting a wavelength. The rotation axis about which the diffraction grating rotating unit 52 rotates the diffraction grating 51 is parallel to the rotation axis of the mirror rotating unit 23.

The operation of such an apparatus is substantially similar to the operation of the apparatus shown in FIG. 1 but differs in that the diffraction grating 51 performs wavelength distribution of the light from the optical isolator 30 including spontaneous emission light. Only light of a desired wavelength is transmitted through a slit, not shown. Thus, only the light of the desired wavelength excluding unwanted spontaneous emission light is emitted as output light. The rotations of the mirror rotating unit 23 and the diffraction grating rotating unit 52 are synchronized by a synchronizing unit, not shown, so as to select the wavelength of output light.

In the apparatus shown in FIG. 2, since the diffracted light from the diffraction grating 21 of the wavelength selecting unit 20 is split for output light by the beam splitter 40, unwanted spontaneous emission light can be eliminated from the output light. In the apparatus shown in FIG. 3, since the second wavelength selecting unit 50 selects the wavelength, unwanted spontaneous emission light can be eliminated from the output light.

However, in the apparatus shown in FIG. 2, since a part of the light fed back to the optical amplifier unit 10 from the wavelength selecting unit 20 is split by the beam splitter 40 and used as output light, when many light beams are split and used as output light, stable laser oscillation cannot be performed. Therefore, in practice, only approximately 20% of the light from the wavelength selecting unit 20 can be acquired as output light, causing a problem of low-output light.

On the other hand, in the apparatus shown in FIG. 3, the wavelengths of light selected by the wavelength selecting units 20 and 50 must be synchronized, and a synchronizing unit, not shown, is required. Moreover, there is a problem that the structure is complicated by using the two moving parts.

Now, a tunable laser source having a structure capable of acquiring higher output than in FIG. 1 with fewer moving parts will be described (see, for example, JP-A-5-72499 (paragraphs 0009 to 0014, FIG. 1)). This apparatus has such a structure that light from the optical isolator 30 is made incident on an incident port of a transmission optical fiber by using a lens in the apparatus shown in FIG. 1. Then, the light is transmitted through the optical fiber, and the light emitted from an emission port of the optical fiber is collimated by a lens and made incident on the diffraction grating 21. Of the diffracted light diffracted by the diffraction grating 21, only light of a desired wavelength is transmitted through a slit, not shown. Thus, only the light of the desired wavelength excluding unwanted spontaneous emission light is emitted as output light.

However, the transmission of the light from the isolator 30 through the optical fiber has the following problems.

(1) Since the light is made incident on the optical fiber, even if the lens is used, insertion loss (approximately 2 to 3 [dB]) occurs and high output cannot be achieved.

(2) Since the diffraction grating 21 itself is dependent on polarization, if stress, temperature change or the like is applied to the optical fiber, the polarization state of the transmitted light changes and the intensity of the output light changes. That is, even if the intensity of the light outputted from the other end of the optical amplifier unit 10 is constant, the intensity of the output light is not stable. A structure using a polarization maintaining optical fiber may be employed but the cost is high.

(3) If stress, temperature change or the like is applied to the optical fiber, the polarization state changes and the wavelength distribution effect by the diffraction grating 21 changes. Therefore, unwanted spontaneous emission light is included in the output light and the S/N ratio is deteriorated.

(4) For incidence on the optical fiber (particularly single-mode fiber), adjustment by several micrometers is necessary. The adjustment is difficult and susceptible to changes with the lapse of time.

### SUMMARY OF THE INVENTION

Thus, it is an object of this invention to realize a tunable laser source that stably outputs high-output light with reduced spontaneous emission light.

### BRIEF DESCRIPTION OF THE DRAWINGS

FIG. 1 is a structural view showing a conventional tunable laser source (Littman layout type).

FIG. 2 is a structural view showing a conventional tunable laser source (diffracted light output type).

FIG. 3 is a structural view showing a conventional tunable laser source (tunable filter type).

FIG. 4 is a structural view showing a first embodiment of this invention (perspective view).

FIG. 5A is a structural view showing the first embodiment of this invention (top view).

FIG. 5B is a structural view showing the first embodiment of this invention (side view).

FIG. 6 is a structural view showing a second embodiment of this invention.

### DETAILED DESCRIPTION OF THE PREFERRED EMBODIMENTS

Embodiments of this invention will now be described with reference to the drawings.

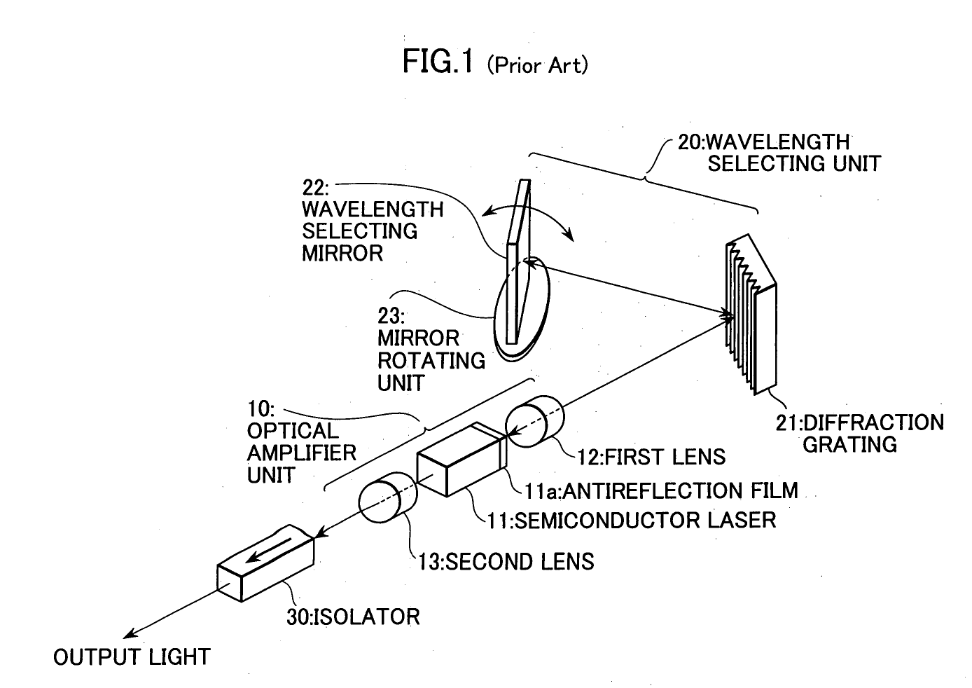

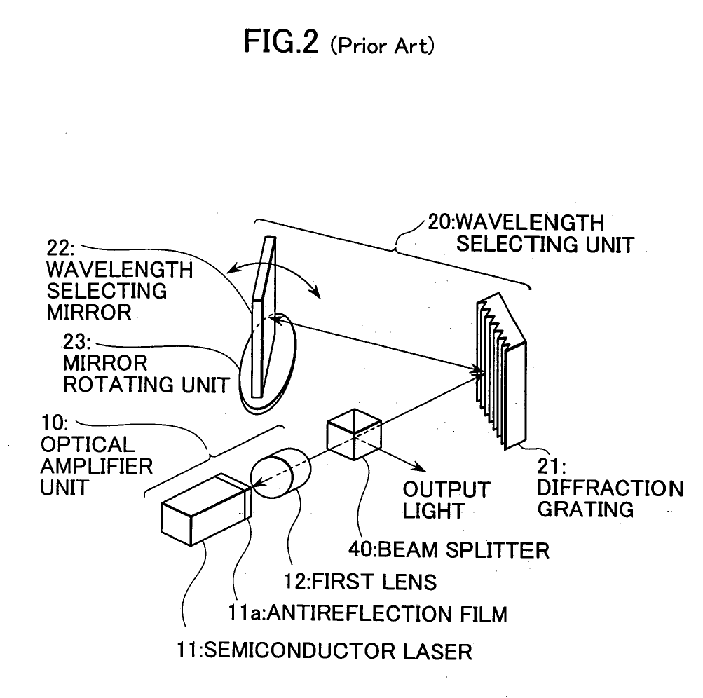

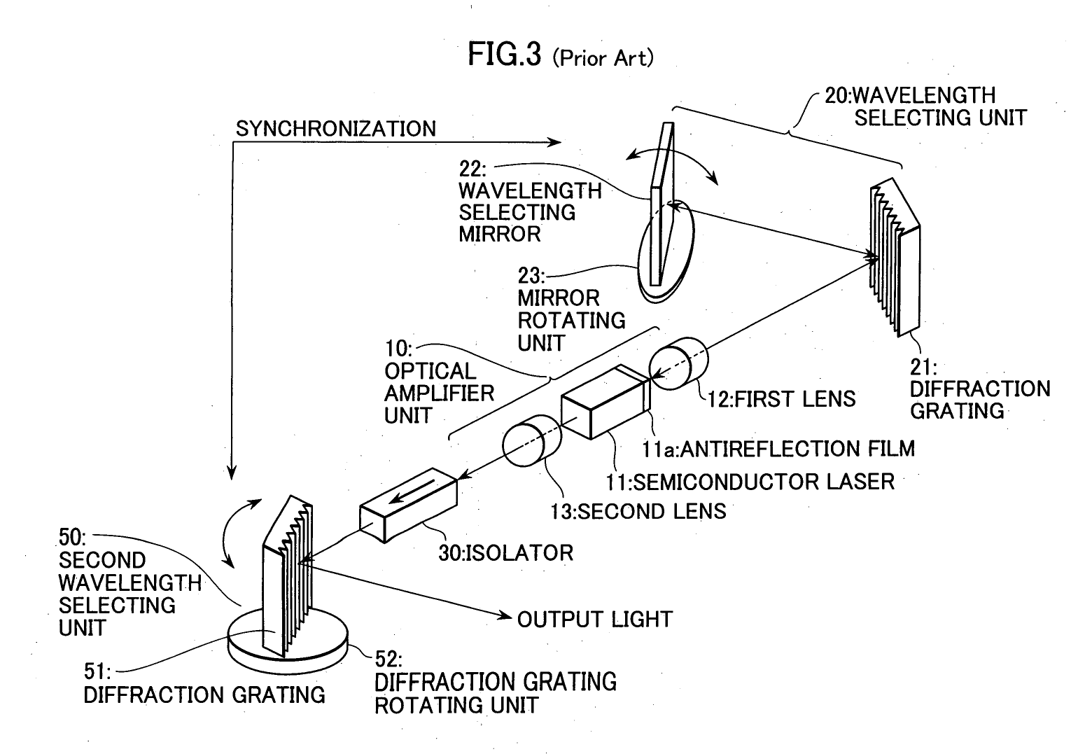

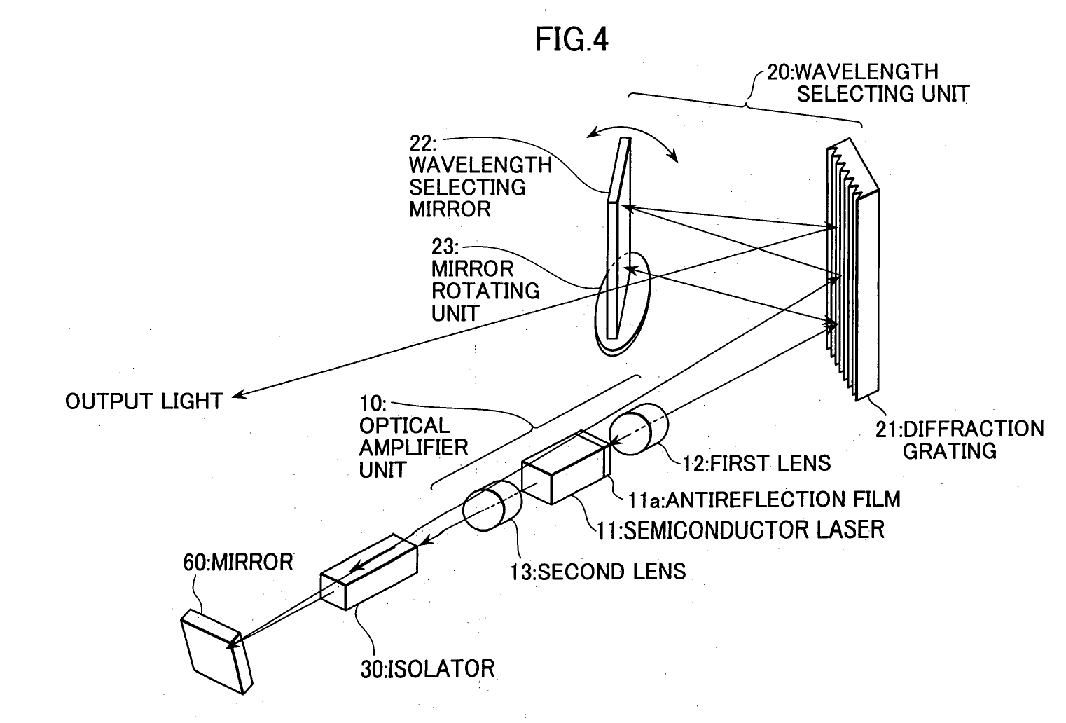

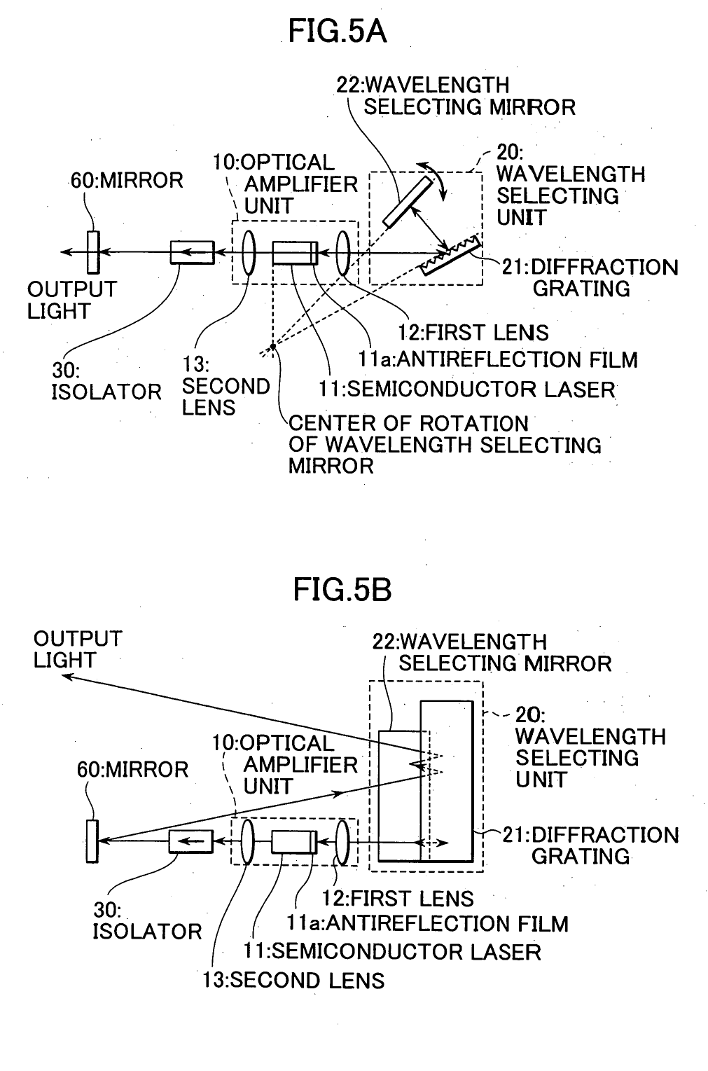

FIG. 4, FIG. 5A and FIG. 5B are structural views showing an embodiment of this invention. FIG. 4 is a perspective view. FIGS. 5A and 5B are views showing an apparatus shown in FIG. 4, as viewed from different angles. FIG. 5A is a top view and FIG. 5B is a side view. In these drawings, the same elements are those shown in FIG. 1 are denoted by the same numerals and will not be described further in detail. In FIGS. 5A and 5B, the mirror rotating unit 23 is not shown. Of course, the center of rotation of the wavelength selecting mirror 22 is at the intersection of a line extending from the diffraction surface of the diffraction grating 21, a line extending from the reflection surface of the wavelength selecting mirror 22, and a line extending from a surface forming an external resonator (strictly speaking, slightly closer to the second lens 13 than to the reflection surface, which is on the other end of the semiconductor laser 11, because of the influence of the refractive index of the semiconductor laser 11) (see FIG. 5A).

In FIG. 4, a mirror 60 for reflecting light incident from the optical isolator 30 directly to the wavelength selecting unit 20 without causing the light to pass through the optical amplifier unit 10 is newly provided. The mirror 60 is inclined with respect to the optical axis of the optical isolator 30 so that it shifts the light from the optical isolator 30 only upward (in the direction along the grooves of the diffraction grating 21) and reflects the light in this manner (see FIGS. 5A and 5B). The reflection surface of the mirror 60 is made up of, for example, a metal coating (aluminum, silver or the like), a dielectric multilayer film or the like. The mirror 60 may reflect only light of a predetermined wavelength range (for example, around 1500 nm used in optical communications) by adjusting the thickness of the film.

The operation of such an apparatus will now be described.

Light emitted from one end of the semiconductor laser 11 is collimated by the first lens 12 and becomes incident on the diffraction grating 21. The light incident on the diffraction grating 21 is diffracted by the diffraction grating 21, then distributed in wavelength at a different angle for each wavelength, and becomes incident on the wavelength selecting mirror 22. Of the light incident on the wavelength selecting mirror 22, only light of a predetermined wavelength is reflected on the same optical path to the diffraction grating 21. The wavelength of the light to be reflected on the same optical path is selected by the mirror rotating unit 23.

Then, the light incident on the diffraction grating 21 is again distributed in wavelength, and only light of a wavelength selected by the wavelength selecting unit 20 is converged on the semiconductor laser 11 by the first lens 12 and thus fed back. The other end of the semiconductor laser 11 and the wavelength selecting mirror 22 form an external resonator, which performs laser oscillation.

On the other hand, light emitted from the other end (end surface where the antireflection film 11a is not provided) of the semiconductor laser is collimated by the second lens 13, then transmitted through the optical isolator 30 and becomes incident on the mirror 60. The light is substantially totally reflected by the mirror 60 and becomes incident directly on the diffraction grating 21 of the wavelength selecting unit 20 without passing through the optical isolator 30 and the optical amplifier unit 10. The reflected light from the mirror 60 becomes incident at a position on the diffraction grating 21 that is shifted only upward from the position on the diffraction grating 21 at which the transmitted light from the first lens 12 becomes incident.

The light incident on the diffraction grating 21 is diffracted by the diffraction grating 21, then distributed in wavelength at a different angle for each wavelength, and becomes incident on the wavelength selecting mirror 22. Then, of the light incident on wavelength selecting mirror 22, only light of a predetermined wavelength is reflected on an optical path on the diffraction grating 21 shifted only upward. Moreover, the light incident on the diffraction grating 21 is again distributed in wavelength and emitted, and only light of a desired wavelength is transmitted through a slit, not shown. Thus, only the light of the desired wavelength excluding unwanted spontaneous emission light is emitted as output light.

Since the wavelength selecting mirror 22 is rotated by the mirror rotating unit 23, selection of the wavelength of the light fed back to the optical amplifier unit 10 from the wavelength selecting unit 20 and selection of the wavelength of the output light emitted from the wavelength selecting unit 20 can be varied, and wavelength sweep of the output light is performed when necessary.

In this manner, the mirror 60 reflects the light incident from the other end of the optical amplifier unit 10 via the optical isolator 30, directly to the wavelength selecting unit 20. Since the wavelength selecting unit 20 selects the wavelength of the light from the mirror 60 and emits the light of the selected wavelength as output light, unwanted spontaneous emission light can be eliminated from the output light. This enables stable output of high-output light with reduced spontaneous emission light by using few moving parts.

Additionally, since the single wavelength selecting unit 20 can perform both the selection of an oscillation wavelength and the filtering of spontaneous emission light synchronized with the oscillation wavelength, it is not necessary to provide two wavelength selecting units having moving parts. Therefore, the structure is simplified and the cost can be reduced.

Moreover, compared with the case where the optical fiber transmits the light from the optical isolator 30 to the diffraction grating 21, the following features can be achieved.

(1) Since the mirror 60 reflects the light from the optical isolator 30 to the diffraction grating 21, substantially total reflection can be performed and a high output with reduced loss can be acquired.

(2) Since the mirror 60 reflects the light from the optical isolator 30 to the diffraction grating 21, the polarization state does not change and the intensity of the output light remains constant and stable. Moreover, the use of the mirror enables reduction in the cost, compared with the use of the optical fiber.

(3) Since the mirror 60 reflects the light from the optical isolator 30 to the diffraction grating 21, the polarization state does not change and the wavelength distribution effect by the diffraction grating 21 is constant. Therefore, unwanted spontaneous emission light can be eliminated and the S/N ratio can be improved.

(4) Since the mirror 60 reflects the light from the optical isolator 30 to the diffraction grating 21, adjustment of incident light becomes easier and is more resistant to changes with the lapse of time.

Furthermore, since the optical isolator 30 reduces the return light to the optical amplifier unit 10, laser oscillation can be stabilized.

It is to be noted that this invention is limited to this embodiment but the following structures can also be employed.

While the apparatus shown in FIG. 4 has the structure in which the optical isolator 30 reduces the return light to the optical amplifier unit 10, the light emitted from the other end of the optical amplifier unit 10 may be made incident directly to the mirror 60 without providing the optical isolator 30.

Also, while the apparatus shown in FIG. 4 has the structure in which the reflected light distributed in wavelength by the diffraction grating 21 is made incident on the slit, not shown, the light may be made incident on an optical fiber and the incident light may be used as output light.

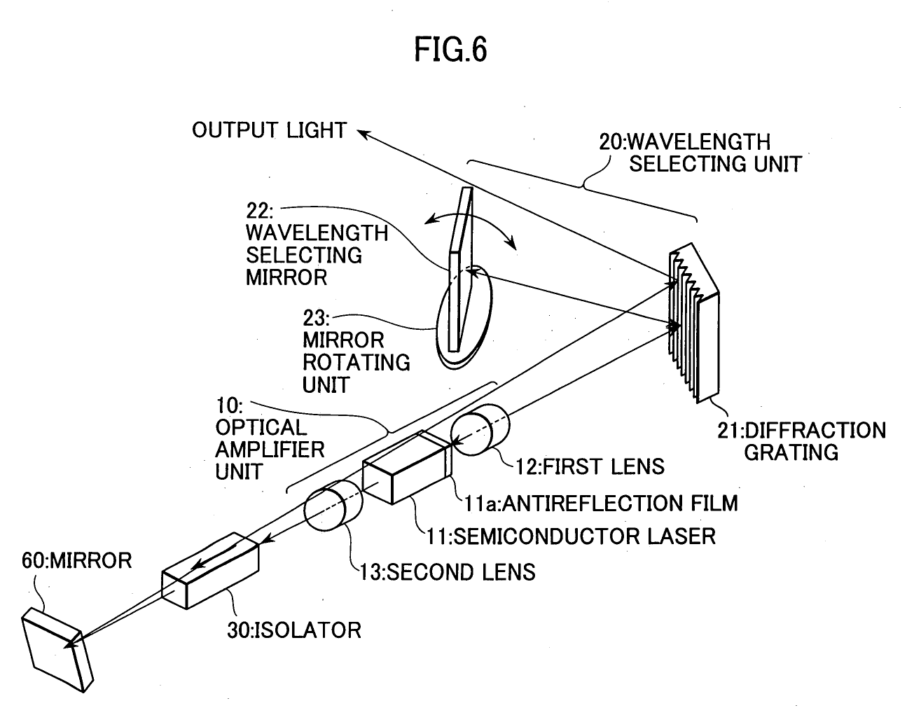

Moreover, while the apparatus shown in FIG. 4 has the structure in which the diffraction grating 21 diffracts the reflected light from the mirror 60 twice and the diffracted light is emitted as output light, the light from the mirror 60 may be diffracted once by the diffraction grating 21 and then emitted as output light, as shown in FIG. 6. Specifically, the diffraction grating 21 performs wavelength distribution of the reflected light from the mirror 60 and only light of a desired wavelength is transmitted through a slit, not shown. That is, the wavelength selecting unit 20 twice diffracts only the light from the one end of the optical amplifier unit 10 by using the diffraction grating 21 and feeds the diffracted light back to the optical amplifier unit 10, while the wavelength selecting unit 20 diffracts the light from the mirror 60 only once by using the diffraction grating 21 and then emits the diffracted light as output light. The slit, not shown, moves on the optical path of the selected wavelength synchronously with the mirror rotating unit 23.

In this manner, the mirror 60 reflects the light incident from the other end of the optical amplifier unit 10 via the optical isolator 30, directly to the wavelength selecting unit 20. Then, the wavelength selecting unit 20 selects a wavelength of the light from the mirror 60 and emits the light of the selected wavelength as output light. Therefore, unwanted spontaneous emission light can be eliminated. This enables stable output of high-output light with reduced spontaneous emission light.

Moreover, while the apparatus shown in FIG. 4 has the wavelength selecting unit 20 in which the wavelength selecting mirror 22 reflects the diffracted light from the diffraction grating 21 again to the diffraction grating 21, the diffracted light from the diffraction grating 21 may be directly fed back to the optical amplifier unit 10 without providing the wavelength selecting mirror 22. Of course, a diffraction grating rotating unit for rotating the diffraction grating 21 is provided instead of the mirror rotating unit 23. This diffraction grating rotating unit performs wavelength selection of the light to be fed back to the optical amplifier unit 10 by the diffraction grating 21 and wavelength selection of output light emitted from the diffraction grating 21.

In this manner, the mirror 60 reflects the light incident from the other end of the optical amplifier unit 10 via the optical isolator 30, directly to the wavelength selecting unit 20. The wavelength selecting unit 20 selects a wavelength of the light from the mirror 60 and emits the light of the selected wavelength as output light. Therefore, unwanted spontaneous emission light can be eliminated. This enables stable output of high-output light with reduced spontaneous emission light by using fewer moving parts.

Moreover, since the single wavelength selecting unit 20 can perform both the selection of an oscillation wavelength and the filtering of spontaneous emission light synchronized with the oscillation wavelength, it is not necessary to provide two wave length selecting unit shaving moving parts. Therefore, the structure is simplified and the cost can be reduced.

This invention has the following effects.

The mirror reflects the light from the other end of the optical amplifier unit, directly to the wavelength selecting unit. The wavelength selecting unit selects a wavelength of the light from the mirror and emits the light of the selected wavelength as output light. Therefore, unwanted spontaneous emission light can be eliminated. This enables stable output of high-output light with reduced spontaneous emission light.

Since the optical isolator reduces the return light to the optical amplifier unit, laser oscillation can be stabilized.

Since single wavelength selecting unit can perform both the selection of an oscillation wavelength and the filtering of spontaneous emission light synchronized with the oscillation wavelength, it is not necessary to provide two wavelength selecting units having moving parts. Therefore, the structure is simplified and the cost can be reduced. This enables stable output of high-output light with reduced spontaneous emission light by using fewer moving parts.

1. A tunable laser source comprising:
a wavelength selecting unit for selecting a wavelength of incident light and emitting the light of the selected wavelength;
an optical amplifier unit for making light incident on the wavelength selecting unit from one end; and
a mirror for reflecting light from the other end of the optical amplifier unit directly to the wavelength selecting unit;
wherein the wavelength selecting unit feeds the light from the one end of the optical amplifier unit back to the optical amplifier unit and emits the light from the mirror as output light.

2. The tunable laser source as claimed in claim 1, wherein the optical amplifier unit comprises:
a semiconductor laser having an antireflection film at its one end;
a first lens for collimating light emitted from the one end of the semiconductor laser, making the collimated light incident on the wavelength selecting unit, and converging light fed back from the wavelength selecting unit to the one end of the semiconductor laser; and
a second lens for collimating light emitted from the other end of the semiconductor laser and emitting the collimated light.

3. The tunable laser source as claimed in claim 1, wherein an optical isolator for reducing return light to the optical amplifier unit is provided between the optical amplifier unit and the mirror.

4. The tunable laser source as claimed in claim 1, wherein the wavelength selecting unit comprises:
a diffraction grating for performing wavelength distribution of incident light;
a wavelength selecting mirror for reflecting the light distributed in wavelength by the diffraction grating to the diffraction grating; and
a mirror rotating unit for rotating the wavelength selecting mirror to perform wavelength selection of light fed back to the optical amplifier unit by the diffraction grating and wavelength selection of output light.

5. The tunable laser source as claimed in claim 1, wherein the wavelength selecting unit comprises:
a diffraction grating for performing wavelength distribution of incident light;
a wavelength selecting mirror for reflecting the light distributed in wavelength by the diffraction grating and emitted from the one end of the optical amplifier unit, to the diffraction grating; and
a mirror rotating unit for rotating the wavelength selecting mirror to perform wavelength selection of light fed back to the optical amplifier unit by the diffraction grating and wavelength selection of output light.

6. The tunable laser source as claimed in claim 1, wherein the wavelength selecting unit comprises:
a diffraction grating for performing wavelength distribution of incident light; and
a diffraction grating rotating unit for rotating the diffraction grating to perform wavelength selection of light fed back to the optical amplifier unit by the diffraction grating and wavelength selection of output light.
